(19) United States
(12) Patent Application Publication
(10) Pub. No.: US 2006/0179157 A1
(43) Pub. Date: Aug. 10, 2006

(54) System and method for discerning the authenticity of the sender and controlling the routing of electronic messages prior to said messages reaching a recipient's device

(76) Inventor: Sam Huang, Spruce Grove (CA)

Correspondence Address: Sam Huang, 17523-100 Ave, Edmonton Alberta, T5S2B8, CA

(21) Appl. No.: 11/054,129

(22) Filed: Feb. 10, 2005

(51) Int. Cl. G06F 15/173; G06F 15/16

(52) U.S. Cl. 709/238; 709/206

(57) ABSTRACT

A system and method for discerning the authenticity of the sender and controlling the routing of electronic messages prior to said messages reaching a recipient's device within a variety of mediums such as email servers, local networks, intranets, wireless cellular telephone systems, wireless mobile telephones, separate computer device and wireless personal digital assistant systems; enabling the information header and address of the messages to undergo scrutiny; automatically responding to and routing said messages according to administrator and/or recipient definable parameters prior to any of the said messages reaching the recipient's device, resulting in the recipient, recipients, corporation or other entity being protected from potentially damaging and/or excessive amounts of unwanted messages.

### CROSS-REFERENCE TO RELATED APPLICATIONS

Not applicable.

### STATEMENT REGARDING FEDERALLY SPONSORED RESEARCH OR DEVELOPMENT

This patent application is not funded or supported by any federally sponsored research and development fund.

### REFERENCE TO SEQUENCE LISTING, A TABLE, OR A COMPUTER PROGRAM LISTING COMPACT DISK APPENDIX

Not applicable.

### BACKGROUND OF THE INVENTION

### Field of the Invention

The present invention relates generally to any communication system whereby users can receive text messages. The messages could contain text only, or could be a combination of text and graphics. The messages could also contain other attachments that contain various forms of information or even malicious code. In particular, the present invention relates to a system and method for determining the authenticity of the sender and controlling the routing of the message without examining the message contents. More specifically, the present invention will prevent a recipient from receiving large amounts of messages (also referred to as spam) and/or potentially damaging messages, and will enable the targeted recipient and/or recipient's administrator the ability to define parameters of the message handling system and method.

Every day thousands of communication system users receive various types of unwanted messages. Most of these unwanted messages are sent to users of internet email systems, however messages are also being sent to users of cellular or mobile telephones that have text messaging capability, as well as users of personal digital assistants. Common words and phrases used for these unwanted messages are “spam”, “viruses”, “Unsolicited Commercial Email (UCE)”, and “Unsolicited Bulk Email (UBE)”.

The senders of the unwanted messages are often trying to advertise some kind of goods or service. Other senders of unwanted messages have the intent of causing damage to or expense to an individual or a corporation such as that of a sender that sends viruses or other types of malicious code. Damage and expense can also result when a corporation's message server receives excess amounts of messages so that it slows down or stops working. Several types of received messages are “unwanted”. Most of these messages can be classified as “spam” while others can be classified as “viruses”. In either case, damage to a corporation's message system can result. The resultant effect of this for the corporation is a loss of money—either due to excessive amounts of employee's time being spent sorting through the large amount of unwanted messages, or due to the damaging nature of a message that contains a virus or other malicious code.

Recipient addresses are gathered in a variety of ways. Various email address harvesting tools are available on the internet that scans information that is available on the internet. Corporations may have staff directories posted that includes email addresses and other personal information. Large corporations that have thousands of users with devices connected to a message system may need to deal with many thousands of unwanted messages in one day. Many corporations do not have the equipment, manpower or system and method of controlling these unwanted messages from entering the recipient's devices. The end result can be a loss of time, or even worse, a whole computer system may be crippled or shut down due to the large amount of unwanted messages that are received.

To combat the amount of spam that has hit message systems, many different types of products have emerged. One such product is available with software packages such as Lotus Notes™. (Lotus Notes is a trademark of IBM). This method is designed to block a user from receiving e-mails from particular e-mail addresses that include particular keywords or character strings in the subject line or the message body. Many senders of spam, viruses and other malicious code have developed ways to overcome message address detection systems. This approach is vulnerable in that marketers and other senders of unwanted messages can quickly adjust an address from which unsolicited e-mails are transmitted, thereby quickly outdating address blocking lists.

Other known e-mail filtering techniques are based upon inclusion lists, such that any message received from any source other than one that is in the inclusion list is discarded. While this may operate with some degree of functionality, the user must continually update the inclusion lists. It is likely that this type of product will easily become outdated resulting in non-functionality.

Another method combines the use of blocking lists as well as inclusion lists. U.S. Pat. No. 6,023,723 describes a filtering system that filters e-mail at a user's network computer according to a list of desired addresses and character strings as well as undesired addresses and character strings. Any e-mail that is discarded is sent to a “holding area” so that the user can view the message there. This would prevent the potentially unwanted message from entering the recipient's device, however it must enter the corporation's server so that the user can view the message. This is a serious deficiency in that keeping unwanted messages out of a corporation's server and recipient's device is very important.

Still another method uses the sender address, and a resultant list of approved sender addresses as the code by which the incoming message is accepted or rejected. In U.S. Pat. No. 6,691,156 to Drummond, a method exists whereby an email message is sent back to the sender when a message for a recipient is received by an e-mail server. If a positive response is received by the e-mail server that contains the same sender address as the initial message, the message is released for delivery to the recipient. This method also contains a deficiency in that senders of spam or unwanted messages often change their outgoing address, and have the ability to send messages from seemingly authentic sender addresses.

Several deficiencies exist in all products, systems and methods previously referred to for controlling unwanted messages. First, some of the products previously referred to allow the message to arrive at the recipient's device, or at the minimum, are allowed to enter a message server within a corporation. Once this happens, the message systems and/or the recipients devices are in danger of being overloaded with too many messages, or may experience viruses or other malicious code entering them. Secondly, some of the products previously referred to examine the text or body of the message to determine if there are any unwanted words or phrases within that area of the message. Due to the personal nature and privacy required for messages, this is not an acceptable method. Thirdly, senders have the ability to change the address from which it appears the message is coming from. This makes the message confirmation step unreliable. Fourthly, the products previously referred to do not allow a corporation or user group to tailor all aspects of the system and method. Many of the systems and methods previously referred to are only useful for a limited scope of user groups or corporations. Some of the systems and methods referred to do allow some degree of user parameters to be set, however the scope of this is limited.

All of the systems and methods identified above apply only to e-mails that are received at a recipient's computer or portable personal digital computing device. This is also hereby identified as a deficiency in that unwanted messages are also being received by users of cellular and mobile telephones, as well as personal digital assistants, and typical computer e-mail systems.

Contained within the “Canspam Act of 2003” are twelve findings of the Congress of the United States of America. The twelve findings of this group are:
1. Electronic mail has become an extremely important and popular means of communication, relied on by millions of Americans on a daily basis for personal and commercial purposes.
2. The convenience and efficiency of electronic mail are threatened by extremely rapid growth in the volume of unsolicited commercial electronic mail. Unsolicited commercial electronic mail is currently estimated to account for over half of all electronic mail traffic, up from an estimated seven percent in 2001, and the volume continues to rise. Most of these messages are fraudulent or deceptive in one or more respects.
3. The receipt of unsolicited commercial electronic mail may result in costs to recipients who cannot refuse to accept such mail and who incur costs for the storage of such mail, or for the time spent accessing, reviewing, and discarding such mail, or for both.
4. The receipt of large number of unwanted messages also decreases the convenience of electronic mail and creates a risk that wanted electronic mail messages, both commercial and noncommercial, will be lost, overlooked, or discarded amidst the larger volume of unwanted messages, thus reducing the reliability and usefulness of electronic mail to the recipient.
5. Some commercial electronic mail contains material that many recipients may consider vulgar or pornographic in nature.
6. The growth in unsolicited commercial electronic mail imposes significant monetary costs on providers of Internet access services, businesses, and educational and nonprofit institutions that carry and receive such mail.
7. Many senders of unsolicited commercial electronic mail purposefully disguise the source of such mail.
8. Many senders of unsolicited commercial electronic mail purposefully include misleading information in the messages' subject lines in order to induce the recipients to view the messages.
9. While some senders of commercial electronic mail messages provide simple and reliable ways for recipients to reject receipt of commercial electronic mail from such senders in the future, other senders provide no such “opt-out” mechanism, or refuse to honor the requests of recipients not to receive electronic mail from such senders in the future, or both.
10. Many senders of bulk unsolicited commercial electronic mail use computer programs to gather large numbers of electronic mail addresses on an automated basis from Internet websites or online services where users must post their addresses in order to make full use of the website or service.
11. Many States have enacted legislation intended to regulate of reduce unsolicited commercial electronic mail, but these statutes impose different standards and requirements. As a result, they do not appear to have been successful in addressing the problems associated with unsolicited commercial electronic mail.
12. The problems associated with the rapid growth and abuse of unsolicited commercial electronic mail cannot be solved by Federal legislation alone. The development and adoption of technological approaches and the pursuit of cooperative efforts with other countries will be necessary as well.

Any unwanted message system and method should satisfy the findings contained within the above noted document.

### REFERENCES CITED

U.S. Patent Documents

| | | |
|---|---|---|
| 6023723 | February, 2000 | McCormick et al. |
| 6029164 | February, 2000 | Birrell et al. |
| 6029195 | February, 2000 | Herz |
| 6112227 | August, 2000 | Heiner |
| 6199102 | March, 2001 | Cobb |
| 6249805 | June, 2001 | Fleming, III |
| 6292795 | September, 2001 | Peters et al. |
| 6330590 | December, 2001 | Cotton |
| 6460050 | October, 2002 | Pace et al. |
| 6546516 | April, 2003 | Kirsch |
| 6546390 | April, 2003 | Pollack et al. |
| 6654787 | November, 2003 | Aronson et al. |
| 6691156 | February, 2004 | Drummond, et al. |
| 6732149 | May, 2004 | Kephart |
| 6757830 | June, 2004 | Tarbotton et al. |
| 6769016 | July, 2004 | Rothwell et al. |
| 6779021 | August, 2004 | Bates et al. |
| 6772196 | August, 2004 | Kirsch et al. |

### ADDITIONAL REFERENCES

RFC 821, Simple Mail Transfer Protocol, Jonathan B. Postel, Information Sciences Institute, University of Southern California, August 1982
Canspam Act of 2003, One Hundred Eighth Congress of the United States of America, S. 877, January, 2003
Fighting Spam from Canada, Suzanne Morin, Canadian Privacy Law Review, Volume 1 Number 8, May 2004

### SUMMARY OF THE INVENTION

In view of the foregoing, it is therefore an object of the present invention to provide an improved message handling system and method that will function in a variety of platforms (cellular telephones, mobile phones, personal digital assistant systems, computer e-mail systems). According to the present invention, a message is released to a recipient's device only after the message sender address and message “Simple Mail Transfer Protocol” (SMTP) delivery path is verified as being from a wanted sender. The body or text of the message is not examined due to the personal and private nature of messages.

The message is received by a server that contains a “Message Transport Agent” (MTA). From there, the present invention contains corporate and recipient tables that contain welcome and unwelcome sender addresses. After the message passes through a welcome table, it then must undergo SMTP delivery path verification. A confirmation e-mail may be sent back to the sender, asking the sender if he/she actually intended to send the message to the recipient. When this confirmation e-mail is sent, the system creates a special address so that the recipient's real address is not revealed. When a positive reply is received back from the original sender, the original message is released to a pending release holding area, depending on how the recipient has set the parameters within the system. All special or temporary addresses that the system generates for the purpose of confirming a sender's authenticity have parameters that can be set by the recipients that impose a length of time whereby the system identifies the special or temporary address as being active.

While the foregoing has outlined some of the more pertinent objects and features of the present invention, these objects and features should be construed to be illustrative of the more prominent features and applications of the invention. Several other beneficial results can be realized by implementing the invention. Please refer to the following detailed description of the preferred embodiment.

### BRIEF DESCRIPTION OF THE DRAWINGS

For a more complete understanding of the present invention and the advantages of the system, reference should be made to the following detailed description taken in connection with the accompanying drawing in which:

FIG. 1 is contained within an SMTP based client-server system in which the present invention is implemented;

FIG. 2 contains a flowchart illustrating an embodiment of the present invention; and

FIG. 3 displays a continuation of the flowchart from FIG. 2; and

FIG. 4 contains a continuation of the flowchart from FIG. 2; and

FIG. 5 contains a continuation of the flowchart from FIGS. 2 and 3 that is present in various messaging systems or MTA's through which the recipient may receive messages. The present invention triggers the SMTP based client-server system to deliver the message to the recipient's device.

### DETAILED DESCRIPTION OF THE PREFERRED EMODIMENT

Much of the following description requires the reader to follow the attached diagram.

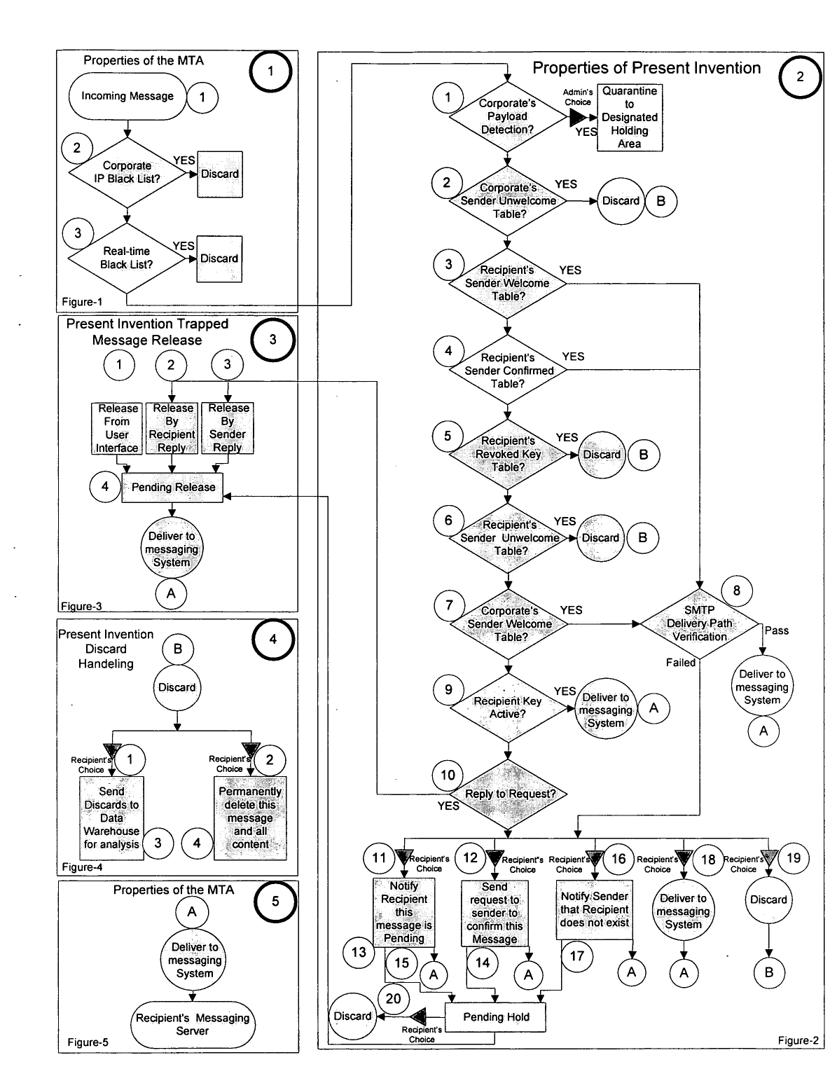

A message is received by an SMTP client-server system (server) that is targeted for a recipient. The message or multiples of messages are held within the server (FIG. 1) until the present invention (FIGS. 2, 3, 4) has examined the sender information of the message, and routed said message according to administrator and/or recipient defined parameters.

Within a MTA (FIG. 1), various filters may be employed to route the message toward the recipient and through the present invention or to discard. If the filters route the message to discard, the message is deleted, and does not proceed any further. If the MTA forwards the message on, the present invention begins its analysis at FIG. 2, step 1.

At FIG. 2, step 1, the present invention determines if the message contains attachments. If the attachments are of the type that have been identified by an administrator, and stored in a table, the message is subject to being held by the present invention in a computer based device that is attached to the recipient's message system. If the message does not contain attachments that are listed in the administrator's table, the message is routed to FIG. 2, step 2.

At FIG. 2, step 2, the present invention compares the message sender address to addresses that are listed in a corporate unwelcome table. The addresses contained in this table are manually inserted by an administrator. If the message sender address is listed in the said table, the message is sent to discard, shown at step B in FIG. 4. If the message sender address is not listed in this unwelcome table, the message is routed to FIG. 2, step 3.

At FIG. 2, step 3, the present invention compares the message sender address to addresses that are listed in the recipient's sender welcome table. If the sender address is not listed in this table, the message is routed to FIG. 2, step 4. If the sender address is listed in this table, the message is routed to FIG. 2, step 8. At FIG. 2, step 8, the SMTP delivery path is verified. The parameters in this step are obtained from information gathered from internet web sites like Global Registries, or by comparing the name and I.P. address in this message with previously received messages. If the message's SMTP delivery path is verified, the message is routed to delivery through the MTA in FIG. 5. If the SMTP deliver path is not verified, the message is routed to one of five possible recipient choices (notify recipient the message is pending, or send request to sender to confirm this message, or notify sender that the recipient does not exist, or deliver to messaging system in FIG. 5, or route the message to discard in FIG. 4 where further recipient defined parameters exist).

At FIG. 2, step 5, the present invention determines if the message has been sent to a temporary address that has been created by the present invention for the purpose of querying the sender. If the temporary address is revoked or no longer valid, the message is routed to discard in FIG. 4 where further recipient defined parameters exist. If the temporary address has not been revoked and is still valid, the message is routed to FIG. 2, step 6.

At FIG. 2, step 6, the present invention determines if the message sender address is listed in the recipient's sender address unwelcome table. If the sender address is listed in this table, the message is routed to discard in FIG. 4 where additional recipient defined parameters exist. If the sender address is not listed in this table, the message is routed to FIG. 2, step 7.

At FIG. 2, step 7, the present invention determines if the message sender address is listed in the corporate sender welcome table. If the sender's address is listed in this table, the message is routed to FIG. 2, step 8, where the SMTP delivery path is verified. If the SMTP delivery path is verified, the message is routed to delivery through the MTA in FIG. 5. If the sender's address is not listed in the corporate sender welcome table, the message is routed to FIG. 2, step 9.

At FIG. 2, step 9, the present invention determines if the message has been sent to one of the temporary email addresses that the system may have created. If the message has been sent to a valid temporary email address that was created by the system, the message is routed to delivery through the MTA in FIG. 5. If the message fails this step, the message is routed to one of five recipient controlled parameters (notify recipient this message is pending, or send request to sender to confirm this message, or notify sender that recipient does not exist, or deliver message through MTA in FIG. 5, or send message to discard in FIG. 4, step B.

At FIG. 2, step 10, the present invention determines if the message is a reply to the system's request for confirmation sent to the sender. If the system determines that the message is a reply to its request for confirmation, the message is routed to FIG. 3, where the message is placed in pending release. Recipient defined parameters control how the message is handled in FIG. 3. The recipient can release the message (the system sends a message to the recipient that the message is being held in “pending release”), or the recipient can release the message for delivery through a web interface, or the recipient can set a parameter whereby the message is released by the sender's reply to the system's confirmation query.

At FIG. 2, step 10, the present invention determines if the message is a reply to the system's request for confirmation sent to the sender. If the system determines that the message is not a reply to its request for confirmation, the message is routed to a set of user defined variables. If the recipient has set a parameter at FIG. 2, step 11 to “notify the recipient that this message is pending”, the recipient will get a message indicating the message is pending. The recipient can also set a parameter at FIG. 2, steps 13 and 15 respectively to have the message either sent to pending hold, or to delivery through the MTA in FIG. 5. FIG. 2, step 12 is another recipient defined parameter following FIG. 2, step 10 whereby the system would send a request to the sender to confirm that they indeed did send the message. From FIG. 2, step 12, the recipient could also set parameters whereby the present invention either places the message in “pending hold”, or sends the message to delivery in FIG. 5. From FIG. 2, step 16, the system would send a message back to the sender indicating that “the recipient does not exist”. The message that came to this point in the system would then be routed to pending hold, or to delivery in FIG. 5, depending once again on recipient defined parameters. Two other recipient defined parameters exist in the present invention when a message passes through FIG. 2, step 10; step 18 would cause the message to be routed for delivery in FIG. 5 through the MTA, or to step 19, whereby the message would be routed to discard in FIG. 4.

At FIG. 4, step B, a message is routed to discard. There are two recipient defined parameters whereby the recipient can set a parameter to permanently delete the message and all of its content, or the recipient can have the discarded message sent to a data warehouse for analysis. The data warehouse could be located at some type of security agency, either within the corporation or outside the corporation, or both, whereby the message is examined, along with all sender information to determine if the sender of the message has broken any laws. Further action can then be taken by the security division or agency if laws are deemed to be broken.

One of ordinary skill will recognize that the present invention provides many advantages over the prior art. The present invention is simple to implement and manage. There is no need for an administrator or recipient within a corporation to constantly monitor incoming messages to determine if they are desired messages. The functionality of the present invention gives superior blocking to unwanted messages, not only in typical e-mail computer systems, but also within cellular or mobile telephone systems, as well as personal digital assistant systems. As per the findings of the United States Congress, a system and method is needed to handle or route incoming messages that are not wanted. The new invention identified and described herein is such a system and method.

All of the processes and routings, whether system generated or user defined, are contained within a computer program. This said computer program can be stored in a hard drive, other computer memory, or in removable memory such as an optical disk (for use in a CD ROM), floppy disk, or removable memory key that is attached to a USB port. The said computer program could also be downloaded via the Internet or other computer network.

The term “server” should be broadly construed to mean a computer, computer platform, or any component thereof.

Having thus described our invention, what we claim is new and desire to secure by letter a patent. Particular claims of our invention are disclosed in the attached claims herein.

1. A system for and method of trapping and/or routing electronic messages sent to recipients comprising of:
an email component at a network server, cellular telephone dialer, or wireless personal digital assistant dialer that receives and examines all message addresses and header information; and
analyzes all message addresses and header information and compares them to corporate administrator parameters and/or recipient defined parameters; and
routes all messages according to said corporate administrator or recipient defined parameters.

2. The method of trapping and/or routing electronic messages according to claim 1, said step of analyzing all messages and comparing them to corporate administrator parameters and/or recipient defined parameters and routing all messages to said corporate administrator or recipient defined parameters, further comprising the steps of:
comparing message attachments to the administrator defined parameters and routes the message as per the administrator's choice.

3. The method of trapping and/or routing electronic messages according to claim 1, said step of analyzing all messages and comparing them to corporate administrator parameters and/or recipient defined parameters and routing all messages to said corporate administrator or recipient defined parameters, further comprising the steps of:
comparing the message sender address to the administrator defined parameters found in a corporate unwelcome table and routes the message to “discard”.

4. The method of trapping and/or routing electronic messages according to claim 1, said step of analyzing all messages and comparing them to corporate administrator parameters and/or recipient defined parameters and routing all messages to said corporate administrator or recipient defined parameters, further comprising the steps of:
comparing the message sender address to the recipient defined parameters found in the recipient's welcome table, and routes the message to SMTP delivery path header verification.

5. The method of trapping and/or routing electronic messages according to claim 1, said step of analyzing all messages and comparing them to corporate administrator parameters and/or recipient defined parameters and routing all messages to said corporate administrator or recipient defined parameters, further comprising the steps of:
comparing the message sender address to the recipient defined parameters found in the recipient's confirmed table, and routes the message to SMTP delivery path header verification.

6. The method of trapping and/or routing electronic messages according to claim 1, said step of analyzing all messages and comparing them to corporate administrator parameters and/or recipient defined parameters and routing all messages to said corporate administrator or recipient defined parameters, further comprising the steps of:
generating a temporary email address in order to respond to or query the sender as to whether the sender intended to send the message to the recipient or not without revealing the recipient's real or direct email address.

7. The method of claim 6 wherein the system analyzes whether the message is sent to a temporary email address that is generated by the system, and determining whether the temporary email address has been revoked by the recipient by comparing the message address to the recipient defined parameters found in the recipient's revoked temporary email address table, and routing the message to discard if the temporary address has been revoked.

8. The method of claim 7 wherein the system determines that the message is sent to a temporary email address that is generated by the system, and is not in the recipient's defined revoked list, the message is routed to delivery to the recipient's receiving device.

9. The method of claim 1 wherein trapped messages are stored within a storage device, which is upstream of the intended recipient's device, until the message is released for delivery by the recipient and delivered by the system to the recipient's device.

10. The method of claim 1 wherein discarded messages are sent, according to administrator or recipient defined parameters, to a data warehouse for analysis or are permanently deleted along with all content.

11. The method of claim 4, said step of comparing the message sender address to the recipient defined parameters found in the recipient's welcome table, and routes the message to SMTP delivery path verification, further comprising the steps of:
the system examines all information within the message SMTP delivery path header, and confirms that the information contained therein passes user defined parameters, resulting in the message being routed to delivery or other recipient definable routings.

12. The method of claim 5, said step of comparing the message sender address to the recipient defined parameters found in the recipient's confirmed table, and routes the message to SMTP delivery path verification, further comprising the steps of:
the system examines all information within the message SMTP delivery path header, and confirms that the information contained therein passes user defined parameters, resulting in the message being routed to delivery or other recipient definable routings.

13. The method of claim 11, said step of routing the message to other recipient definable routings, further defined as:
the recipient's choice may route the message to delivery, to discard, to an automatic reply back to the sender that the recipient does not exist, to an automatic request back to the sender to confirm the message, or to notify the recipient that this message is pending.

14. The method of claim 12, said step of routing the message to other recipient definable routings, further defined as:
the recipient's choice may route the message to delivery, to discard, to an automatic reply back to the sender that the recipient does not exist, to an automatic request back to the sender to confirm the message, or to notify the recipient that this message is pending.
